(19) United States
(12) Patent Application Publication
(10) Pub. No.: US 2023/0177412 A1
(43) Pub. Date: Jun. 8, 2023

(54) INTEGRATED SYSTEMS AND METHODS FOR MANAGING BOOKING INFORMATION

(71) Applicant: WHITEWATER WEST INDUSTRIES, LTD., Richmond (CA)

(72) Inventors: Aaron Mendelson, Vancouver (CA); David Black, North Vancouver (CA); Michael Jungen, Orlando, FL (US); Eric Dunaway, Boulder, CO (US); Zachary McCallum, Gunbarrel, CO (US)

(21) Appl. No.: 17/935,855

(22) Filed: Sep. 27, 2022

Related U.S. Application Data
(60) Provisional application No. 63/261,726, filed on Sep. 27, 2021.

(51) Int. Cl. G06Q 10/02; G06Q 30/0601

(52) U.S. Cl. CPC G06Q 10/02; G06Q 30/0633

(57) ABSTRACT

Systems and methods for booking one or more experiences that allows the system to individually manage and customize each user's experience are disclosed. The systems and methods can also be operable to track users at a geographic location or destination and collect data based upon such users and the tracking of such users. The system may be accessible via software applications executed upon mobile devices and/or permanent hardware kiosks and/or via a web-based interface.

### CROSS REFERENCE TO RELATED APPLICATIONS

This U.S. patent application claims priority to Provisional Patent Application 63/261,726 filed on Sep. 27, 2021. The disclosure of this prior application is considered part of the disclosure of this application and is hereby incorporated by reference in its entirety.

### BACKGROUND

### Field of the Invention

The present disclosure relates to systems and methods for managing booking information for a plurality of users in a network environment.

### Description of Related Art

Amusement parks, waterparks, mixed-use theme parks (e.g., coupled with hotels, resorts, etc.), and/or other venues for entertaining guests (“Entertainment Venues”) are popular entertainment destinations where guests congregate within a geographic location that contains a number of entertainment or associated activities (e.g., shows, rides or attractions, dining options, lockers, hotel rooms, concessions, etc.) for the participation of the guests. Entertainment Venues provide such entertainment activities for its guests without having specific data as to what a particular guest is doing at the amusement park or waterpark at any particular time during their visit. Moreover, operators of Entertainment Venues do not have specific data concerning guest demographics and how certain demographics are capable of interacting on a real-time basis with one or more of the entertainment activities provided. One or more of crowd control, payment methods, maintenance of facilities and/or attractions, efficiency of staff activity and/or guest activity, guest convenience, and/or customer service issues in conventional Entertainment Venue operation may be significant issues that can impact guest enjoyment and/or finances.

Current systems and methods for managing booking information at Entertainment Venues provide a user interface (UI) for user account creation and reservations. Reservations can further include a number of potential activities associated with the reservation. The reservations UI display the particular activity (e.g., ride or attraction) that had been reserved by or for the user and organize the reservations by time to reflect a next scheduled activity. However, when a reservation is made by a single user for a plurality of users, the reservations can be assigned to the other users but the currently available systems are unable to customize the experience for the other users.

What is needed are systems and methods for booking one or more experiences at, for example, an Entertainment Venue that allows the system to individually manage and customize each user's experience.

### SUMMARY

Disclosed herein are systems and methods for booking one or more experiences that allows the system to individually manage and customize each user's experience.

One aspect of disclosure provides a method for tracking. The method includes displaying, by a server, a plurality of options including a first option associated with creating a new user account and a second option associated with logging in to a user account. The method also includes determining, by the server, that a first user is logged in to a first user account. When the server determines that that the first user is logged in to the first user account, the method includes displaying, by the server, a dashboard of the first user account. The dashboard is configured to include a plurality of carts. The plurality of carts includes a first cart associated with a first attendee and a second cart associated with a second attendee.

Implementations of the disclosure may include one or more of the following optional features. In some implementations, the dashboard is configured to include a total number of attendees. In some implementations, the dashboard is configured to include a date of activity. In some implementations, the dashboard is configured to include a plurality of attractions. The plurality of attractions includes a first attraction and a second attraction. In some implementations, the method includes determining, by the server, that the first attraction is selected for the first attendee by the first user. In some implementations, when the server determines that the first attraction is selected for the first attendee by the first user, the method includes adding the first attraction to the first cart associated with the first attendee. In some implementations, the dashboard is configured to include at least one item related to souvenirs, sundries, snacks, deserts, beer, wine, or non-alcoholic beverages. In some implementations, the first attendee is associated with a first account, and the second attendee is associated with a second account. In some implementations, the method includes associating a first tag with the first account and associating a second tag with the second account. In some implementations, the first tag is associated with the first account at a point-of-sale (POS) device in data communication with the server.

As used herein, a “tag” is meant to encompass a unique identifier associated with an account. Embodiments of a “tag” include bar codes, RFID tags, RFID cards, wristbands, and the like.

In some implementations, the method includes sensing a plurality of tags including the first tag and the second tag. In some implementations, the method includes determining a movement of the first attendee based on a result associated with sensing the first tag. In some implementations, the method includes determining a movement of the second attendee based on a result associated with sensing the second tag. In some implementations, the method includes storing data of the movement of the first attendee and data of the movement of the second attendee. In some implementations, the method includes determining that the first tag is within a proximity of a kiosk. In some implementations, when the first tag is determined to be within the proximity of the kiosk, the method includes transmitting, by the server, information related to the first account to the kiosk. In some implementations, the method includes displaying the information related to the first account to the first attendee. In some implementations, the first account is the first user account.

Another aspect of the disclosure provides a system for tracking. The system includes data processing hardware and memory hardware in communication with the data processing hardware. The memory hardware stores instructions that when executed on the data processing hardware cause the data processing hardware to perform operations. The operations include displaying a plurality of options including a first option associated with creating a new user account and a second option associated with logging in to a user account. The operations include determining that a first user is logged in to a first user account. When it is determined that that the first user is logged in to the first user account, the operations include displaying a dashboard of the first user account. The dashboard is configured to include a plurality of carts. The plurality of carts includes a first cart associated with a first attendee and a second cart associated with a second attendee.

Implementations of the disclosure may include one or more of the following optional features. In some implementations, the dashboard is configured to include a total number of attendees. In some implementations, the dashboard is configured to include a date of activity. In some implementations, the dashboard is configured to include a plurality of attractions. The plurality of attractions including a first attraction and a second attraction. In some implementations, the operations include determining that the first attraction is selected for the first attendee by the first user. When it is determined that the first attraction is selected for the first attendee by the first user, in some implementations, the operations include adding the first attraction to the first cart associated with the first attendee. In some implementations, the dashboard is configured to include at least one item related to souvenirs, sundries, snacks, deserts, beer, wine, or non-alcoholic beverages. In some implementations, the first attendee is associated with a first account, and the second attendee is associated with a second account. In some implementations, the operations include associating a first tag with the first account and associating a second tag with the second account. In some implementations, the first tag is associated with the first account at a point-of-sale device.

In some implementations, the operations include sensing a plurality of tags including the first tag and the second tag. In some implementations, the operations include determining a movement of the first attendee based on a result associated with sensing the first tag. In some implementations, the operations include determining a movement of the second attendee based on a result associated with sensing the second tag. In some implementations, the operations include storing data of the movement of the first attendee and data of the movement of the second attendee. In some implementations, the operations include determining that the first tag is within a proximity of a kiosk. When the first tag is determined to be within the proximity of the kiosk, in some implementations, the operations include transmitting information related to the first account to the kiosk. In some implementations, the operations include displaying the information related to the first account to the first attendee. In some implementations, the operations include wherein the first account is the first user account.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 9,712,980 B1 to Filatoff et al. published Jul. 18, 2017; US 2013-304536 A1 to Hamachi et al. published Nov. 13, 2014; US 2017-169449 A1 to Briggs et al. published Jun. 15, 2017; US 2019-0304216 A1 to Mendelson et al., published Oct. 3, 2019; US 2020-0357211 A1 to Mendelson et al., published Nov. 12, 2020; and WO 2019/183732 A1 to Mendelson et al., published Oct. 30, 2019.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a system that operates within a defined geographic area and on the internet;

FIG. 2 illustrates an overview of a point-of-sale (POS) hardware station;

FIGS. 3A-H illustrate a series of user-interface screens for a system for tracking users and/or objects at a geographic location and configured to allow the system to individually manage and customize each user's experience and provide data and/or associated features, according to an exemplary embodiment of the disclosure.

### DETAILED DESCRIPTION

The system includes, for example, three modules that can be integrated, operate on a standalone basis, or operate separately as part of another system (e.g., long-range tracking, wait time tracking, safety dispatch, concierge system, etc.). The three modules include a ticketing module, a waiver module, and a point-of-sale (POS) module.

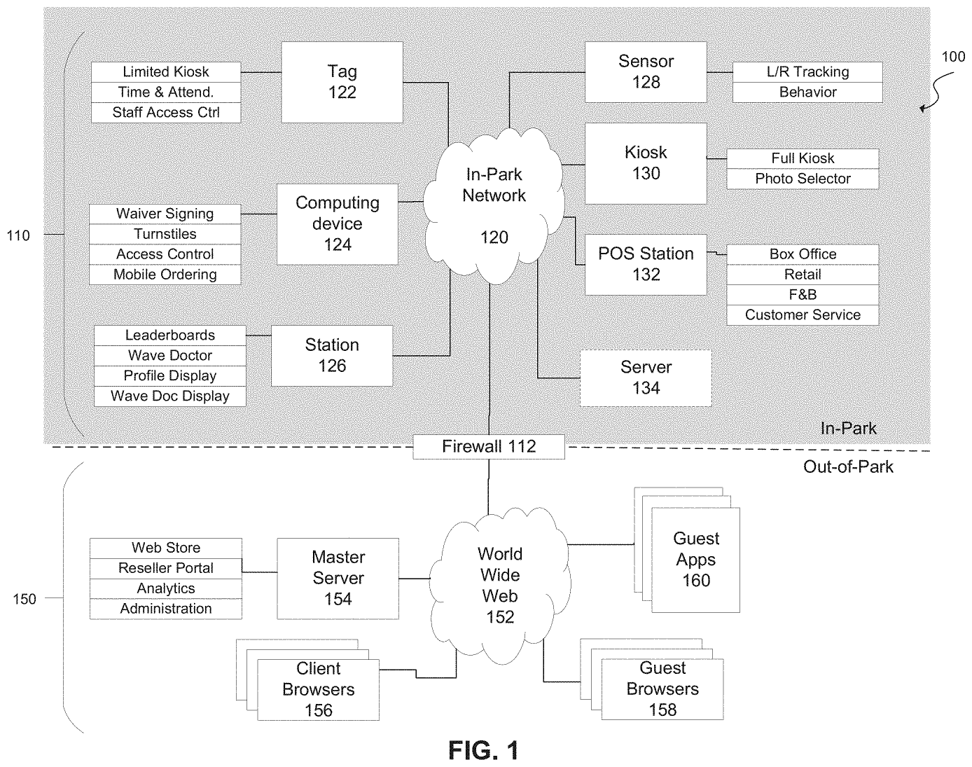

Turning to FIG. 1, the system 100 has two subsystems. The first subsystem 110 is configured to operate with a defined geographic area and the second subsystem 150 operates on the internet 152. The two subsystems are in communication with each other but separated by a firewall 112. The system 100 is operable to work with disparate and un-integrated systems which might be used to handle ticketing, reservations, rentals, POS, safety management, waivers etc. into a single dashboard.

The first subsystem 110, operates within a defined geographic area, such as an amusement park on an in-park network 120. The in-park system 120 further communicates with one or more of the following: one or more tags 122, one or more computing devices 124, such as tablets, one or more stations 126, one or more sensors 128, one or more kiosks 130, one or more point-of-sale stations 132, and an in-park server 134.

The tags 122 may include antennas for long-range tracking of, for example, wristbands. Users (e.g., each user at the destination, a group of users, etc.) may wear or otherwise have associated with them hardware that is capable of being tracked as the user or users movement throughout the destination. Hardware associated with a tag (e.g., a wristband or other wearable or other device with a tracking module or component) may be provided to a user as the user enters the destination and returned by the user as the user exits the destination. In some embodiments, the user may purchase (e.g., pre-purchase, or be given) the hardware and be permitted to keep all or some of the hardware even upon exiting the destination. In some implementations, the tags may be used with a mobile device (e.g., cell phone) or via a machine readable code (e.g., QR code, bar code).

Sensors 128 configured to detect and/or track the hardware may have different ranges (e.g., sensors may have a short-range, such as corresponding to a maximum of a few inches, while other sensors may have a long-range, such as corresponding to roughly 90 ft) and may be placed throughout the destination at locations to sense and track the movement of users and/or objects. The tags 122 can be linked to a specific user account and associated ticket. A user-associated tag allows for location-awareness of individual users and behavior analysis of the individual user which allows the system to communicate user specific information to the user based on an analysis of their behavior. The tags 122 can interact with kiosks to provide point balance information, gamification status, reservation information, etc. Additional information can include time-and-attendance and entrance-exit information which is accessible by the user, a parent or guardian, and/or staff. Additional access control can be provided as well.

The one or more computing devices 124, can be in the geographic location of the first subsystem 110 and can be used to allow user-customization or user-interaction experiences of the system may via a software application that is executed upon a computing device, such as a handheld or other mobile device (e.g., a smartphone, tablet, laptop, etc.). The computing devices 124 are operable to access a function specific web app via the server. The computing devices 124 can also be used for a plurality of additional functions including, but not limited to, signing a waiver, operating turnstiles to allow a user into a particular location, access control, and mobile ordering.

One or more stations 126, can be provided in the geographic location of the first subsystem 110. The stations 126 can include information, such as a leaderboard illustrating performance of an activity by various users in the geographic location participating in a particular event, profile information for a user. In a water park, the station can also provide information for wave creation, wave diagnostics, and wave operation. The tag can also communicate with the one or more stations which allows the one or more stations to generate customized messages for a specific user or groups of users.

The one or more sensors 128 communicate with the tags 122 to collect information from users based on the user's tag.

One or more kiosks 130 can be provided the kiosks can be can be pedestal mounted or wall mounted. The kiosks 130 may comprise a processor, such as an Intel or AMD processor. The kiosks 130 can also include modules for organizing the day or visit, personalization, friends and family, access to concierge features, etc. Kiosks 130 or other permanent or semi-permanent hardware stands may be disposed around a destination to allow users to engage with features of the system. A user may position themselves or some trackable hardware associated with the user within a proximity (e.g., short-range, such as within a few inches) of a sensor of the kiosk 130 that senses the trackable hardware and starts software instructions using a processor. The processor may be connected with memory (or memory may be embedded or on-chip with the processor) in one embodiment for executing software instructions. The processor may have a command console or server input that allows for an operator of the destination to send explicit instructions to the processor of the kiosk (e.g., update firmware, update software, request status, etc.). The kiosk may also be connected (e.g., via wireless and/or through wired connections) with a server, such as a local server associated with the destination and/or a master or global server as discussed throughout. This connection with the server may allow for syncing of data, lookup of data, and/or other communication of data between the server and kiosk, for example, when a user enters a proximity of the kiosk to be sensed by the kiosk and begin use, the data on the local and/or master or global servers is available for display and/or interaction by the kiosk.

Guests can select photos that are available for purchase and/or download by time-range or by scanning a tag (e.g., to determine a time range and/or correct set of photos). Photos can then be purchased and/or downloaded into the user's account.

One or more point-of-sale stations 132 can be provided which are operable to interface via a local network and/or a local server to, for example, register users with tags and/or perform other currency based functions. Some examples of currency-based functions may include purchase and/or rental of wristbands or tracking hardware, payment for access to a location (e.g., amusement part or waterpark) or for access to a particular attraction, or any other form of payment for and/or receipt of credits, rebates, coupons, or other manners of payment or reimbursement associated with a location, venue, device, etc. A point-of-sale station 132 may allow users to interface with the system.

An in-park server 134 can be provided. Use of an in-park server can be determined based on the size of the venue, requirements for real time long-range scan processing, and the like. Additionally, an in-park server 134 may be appropriate when reliability of the internet in a target geographic area is unreliable and/or for other operational considerations.

Turning now to the second subsystem 150, a master server 154 can be provided that operates on the internet 152. The master server 154 is operable to provide real-time, long-range scan processing. Whether to include a master server 154 in a particular system is determined by, for example, reliability of the internet and other operational considerations. The master server 154 can be a processor, such as an Intel or AMD processor, or a full server, such as a Dell server or HP server. Client browsers 156 and guest browsers 158 can access the systems via the internet 152. Additional access via the internet 152 can be provided to a variety of guest apps 160.

There are multiple ways a user can purchase tickets or products, including: (1) on-line via a web portal; (2) using a site specific application (“app”), (3) at a POS terminal; and (4) through a reseller. All tickets are associated with at least one account. Multiple accounts may be associated with each other as, for example, family, friends, squad, or group. One account within the plurality of associated accounts is the primary account. Typically, if a single purchaser purchases multiple tickets for several people, the purchaser might be the primary account at least for that transaction. As will be appreciated by those skilled in the art, when purchasing tickets through a web portal or the app, the customer will be expected to log in in to their account. The customer may log in to the account at the beginning of the process, or the log in may occur at the end of the process, as those skilled in the art will appreciate.

When purchasing tickets on the premises or through a reseller (including a reseller web portal), the tickets are purchased for an unassociated account. However, through the web portal or app, each user can associate their purchased tickets with their individual account and/or tag.

Printed tickets can include, for example, a barcode or QR code. The barcode or QR code can be called other things, such as a V-code, chit, badge, marker, etc. The barcode or QR code represents one or more entitlements for a single guest. An entitlement includes, for example, access to a ride, access to an experience, locker rental, merchandise, or other reservation. The entitlements can also be time specific (e.g., access to a specific ride at a specific date and/or time). For a family of three, for example, three barcodes or QR codes would be created. Each barcode or QR code would be associated with one or more entitlements, where each entitlement is customizable for a particular person. Additionally, a stored value can be associated with each account. The stored value on the ticket can be increased at a public portal, in the app, via a POS terminal, or via the reseller web portal. The barcode or QR code can also be automatically associated with a tag that is associated with a user account.

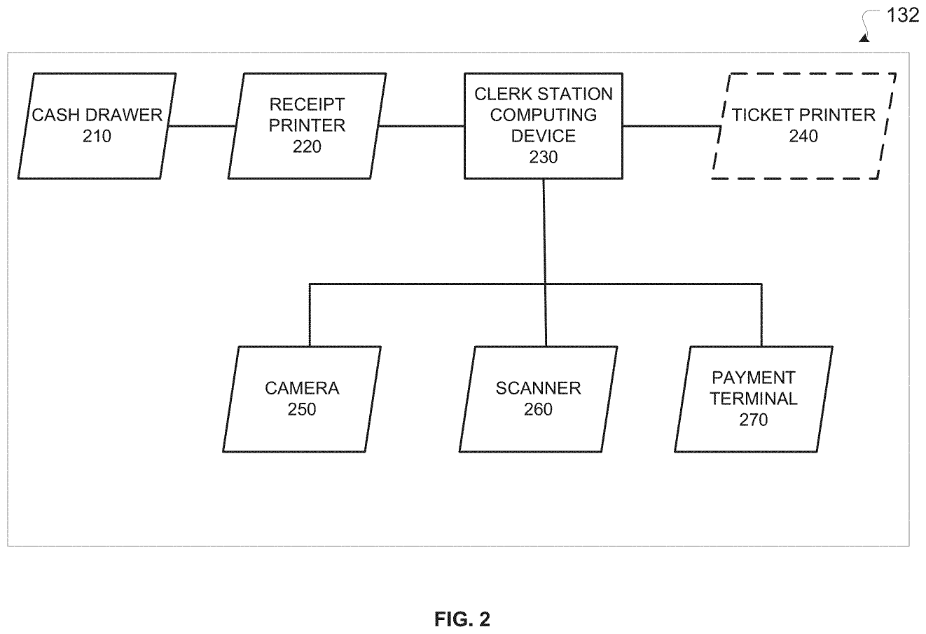

FIG. 2 illustrates an overview of a point-of-sale (POS) station 132. The POS station 132 is shown in FIG. 1 connected to the in-park system 120. Unlike a traditional POS hardware device that requires a local application to be run on the terminal hardware, the disclosed POS station 132 is a viewport into a remote console. The use of a remote console makes the POS hardware device easier to update, remotely manage, install software, configure, and maintain. Additionally a central dashboard can be provided that manages the POS hardware devices (terminals) and the other components of the system shown in FIG. 1. The station 132 comprises one or more of a cash drawer 210, receipt printer 220, clerk station computing device 230, ticket printer 240, camera 250, scanner 260, and payment terminal 270.

The point-of-sale station 132 may also be configured to interface via the local network and/or the local server, for example, to register users with wristbands or tracking hardware and/or perform other currency based functions. Some examples of currency-based functions may include purchase and/or rental of wristbands or tracking hardware, payment for access to a location (e.g., amusement part or waterpark) or for access to a particular attraction, or any other form of payment for and/or receipt of credits, rebates, coupons, or other manners of payment or reimbursement associated with a location, venue, device, etc.

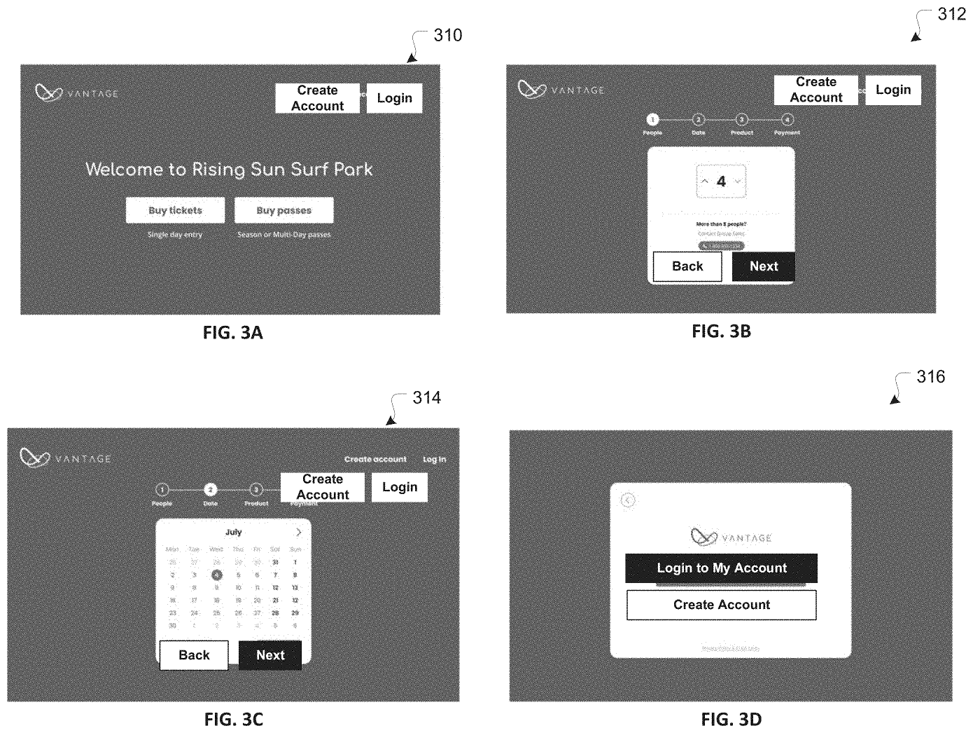

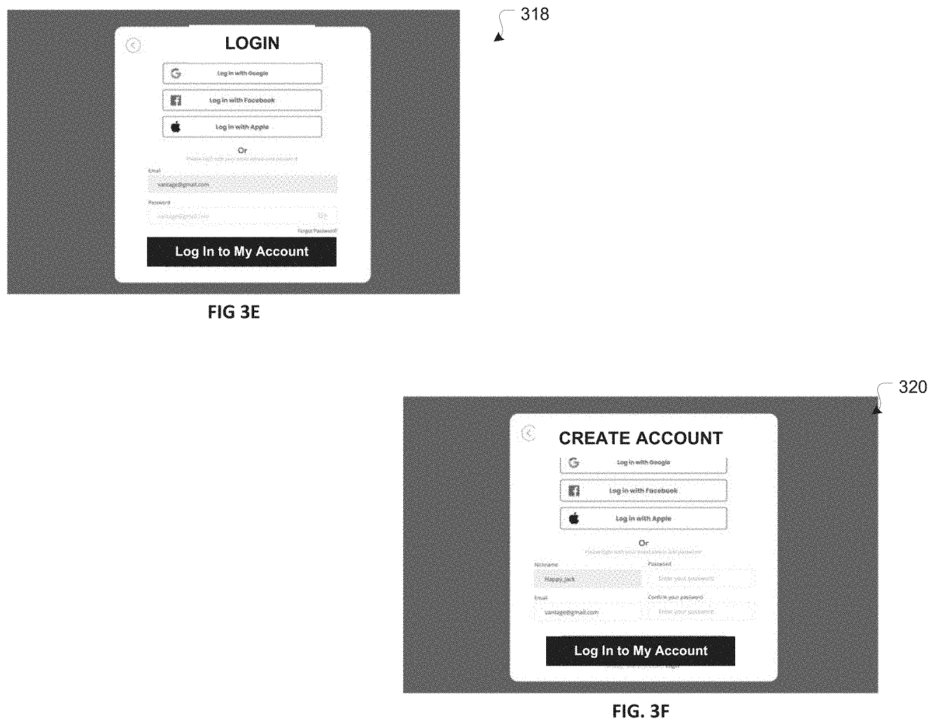

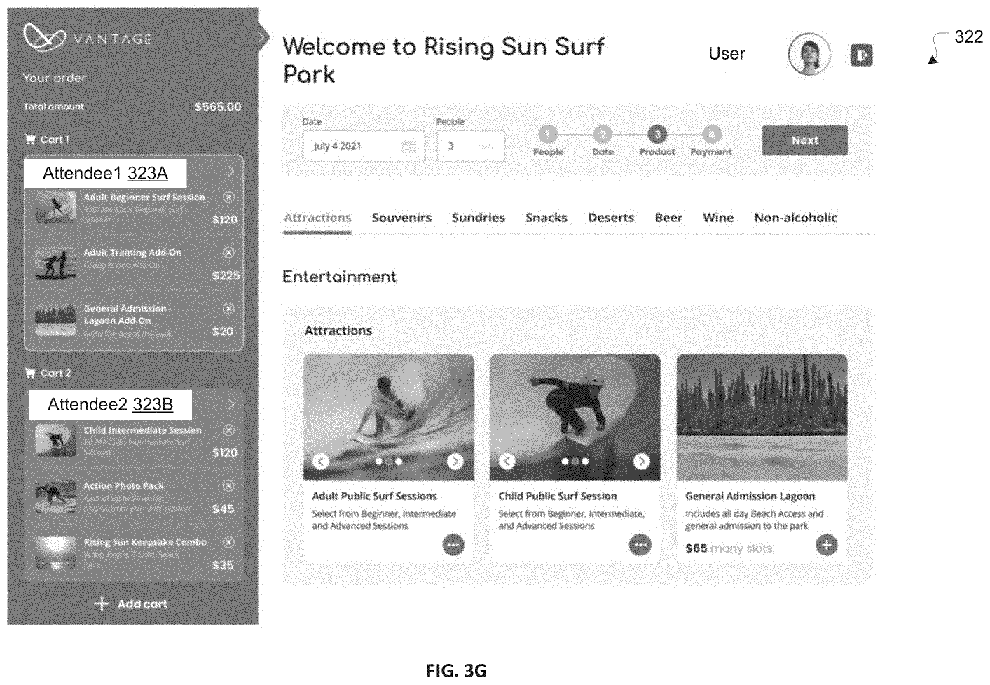

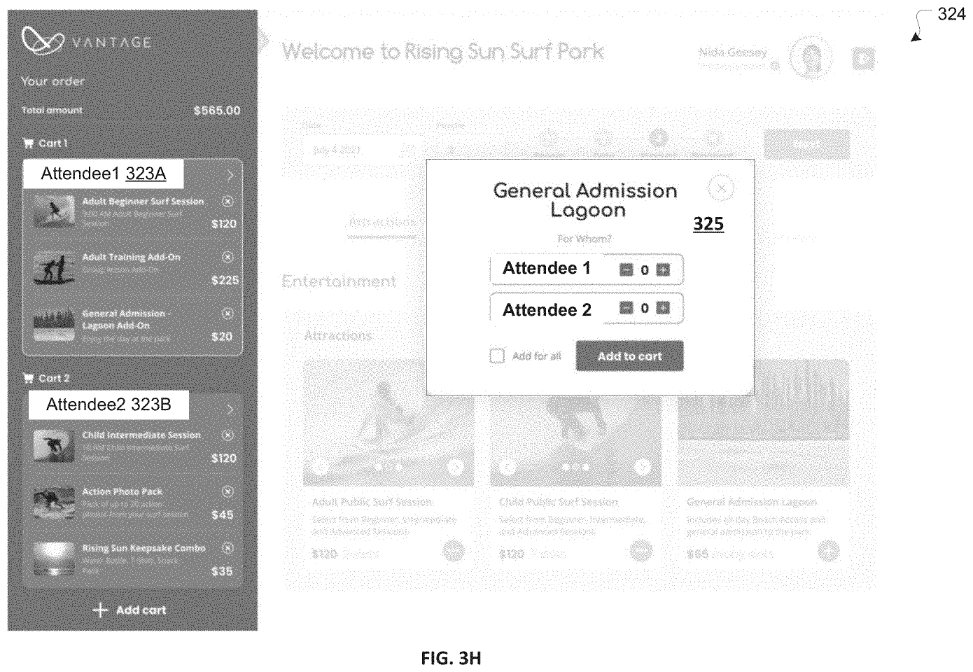

FIGS. 3A-H illustrate a series of exemplary user-interface screens for a system for managing booking information and configured to allow the system to individually manage and customize each user's experience and provide data and/or associated features, according to an exemplary embodiment of the disclosure.

FIG. 3A illustrates an opening screen 310 that provides a user the option of creating an account, logging in to an account, buying tickets, and buying passes. In FIG. 3B during the process of purchasing tickets, the user will be presented with a screen 312 that provides an option to select a number of tickets. Once the number of tickets is selected, as shown in FIG. 3C, the user selects the date for the tickets on a date screen 314. As will be appreciated by those skilled in the art, the steps of selecting a number of tickets and a date for the tickets can occur in either order. FIG. 3D illustrates a login/create account screen 316.

If the user selects login, the user is directed to a login screen 318, shown in FIG. 3E, which provides a variety of login options (e.g., Google, Apple, Facebook, email/password). If the user selects create an account, the user is directed to a ‘Create Account’ page 320, shown in FIG. 3F, which provides a variety of mechanisms for creating an account (e.g., Google, Apple, Facebook, email/password). Optionally, the user may continue as a guest, with the account log in or creation step occur at the end of the process but before completing the transaction.

Once the user is in the system, a dashboard screen 322 as shown in FIG. 3G is provided that summarizes items in a cart organized by attendee, and options for additional attractions, souvenirs, sundries, snacks, desserts, beer, wine, and non-alcoholic beverages. In the embodiment shown in FIG. 3G, carts for a first attendee 323A and a second attendee 323B are shown. From this screen, a user can continue to add entitlements to any attendee's cart—either by date or by item type (sundries, towel service, food credits, e.g.). The user can also proceed to checkout (NEXT) from this page.

FIG. 3H illustrates a screen 324 that demonstrates an exemplary function allowing the user to book and assign entitlements for one or more attendees. The user may select a performance, show, etc., from the available options, including selecting a time, location, or other attributes, as appropriate. For example, for a performance, the user would select the time and seating type; for a meal entitlement, the user may select the total amount to add to the entitlement, but selection of time may not be required, for example. As shown in FIG. 3H, the user has selected an entitlement and is asked to assign the entitlement to one or more users via dialog box 325. In the case of selecting performances, for example, a first attendee may be assigned an entitlement for a performance beginning at, say, 2:00 p.m., while the second attendee may be assigned to a performance beginning at, say 3:30 p.m., as desired. Instead of a dialog box, the user may be presented with a dropdown menu or other means of selecting features that are already known to a person of ordinary skill in the art.

As shown in FIGS. 3G and 3H, the carts are organized for a first attendee 323A and a second attendee 323B. During this process, the user may associate the first attendee 323A and the second attendee 323B with particular users—such as themselves and a friend—or the user may associate the entitlements with a user at a later point. In one implementation, the user may forward a unique code via email or via app to a friend, who may then choose to accept the code to accept the entitlements, thereby associating the entitlements with the recipient's account. In another implementation, the user may assign the entitlement associated with first attendee 323A and/or second attendee 323B to individuals at the park. This may be accomplished by giving the attendees a machine readable code, password, etc., that can be input into a computing device 124 or kiosk 130, and then associated the entitlements with the attendee by tapping or scanning the attendees tag at a sensor. A person of skill in the art will appreciate that this process of assigning entitlements to attendees may be accomplished by other means, and may be accomplished with any number of attendees.

At the park, attendees assigned to a group (or squad, family, friends group, etc.) may enable the ability to share certain entitlements. For example, a group may purchase a quantity of shareable entitlements, such as towels, meal credits, etc. A group leader may then determine how the entitlements may be shared. For example, if a group purchased three towel entitlements for the group, each member of the group may be allowed to pick up one towel on the day, or each member may be allowed to pick up all three towels on the day. Likewise, if the group has purchased $100 in meal credits, a group leader (i.e., the user who originally purchased the entitlement) may choose to allocate $20 to each group member per day. In another implementation, each group member may be allowed to spend up to a certain limit at a time, up to a maximum total amount per day.

In one implementation, members may be added or removed from a group either via the online interface described above in FIGS. 3A through 3H, or through use of computing device 124 or kiosk 130 in the park, or via a guest app. Group entitlements and determination of how entitlements may be distributed throughout a group may be modified in the same manner.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A system for tracking, the system comprising:
data processing hardware; and
memory hardware in communication with the data processing hardware, the memory hardware storing instructions that when executed on the data processing hardware cause the data processing hardware to perform operations comprising:
displaying a plurality of options including a first option associated with creating a new user account and a second option associated with logging in to a user account; and
determining that a first user is logged in to a first user account,
when it is determined that that the first user is logged in to the first user account, displaying a dashboard of the first user account,
wherein the dashboard is configured to include a plurality of carts, and
wherein the plurality of carts includes a first cart associated with a first attendee and a second cart associated with a second attendee.

2. The system of claim 1, wherein the dashboard is further configured to include a total number of attendees.

3. The system of claim 1, wherein the dashboard is further configured to include a date of activity.

4. The system of claim 1, wherein the dashboard is further configured to include a plurality of attractions, the plurality of attractions including a first attraction and a second attraction.

5. The system of claim 4, further comprising:
determining that the first attraction is selected for the first attendee by the first user,
when it is determined that the first attraction is selected for the first attendee by the first user, adding the first attraction to the first cart associated with the first attendee.

6. The system of claim 1, wherein the dashboard is further configured to include at least one item related to souvenirs, sundries, snacks, deserts, beer, wine, or non-alcoholic beverages.

7. The system of claim 1, wherein the first attendee is associated with a first account, and wherein the second attendee is associated with a second account.

8. The system of claim 7, wherein the operations further comprise:
associating a first tag with the first account; and
associating a second tag with the second account.

9. The system of claim 8, wherein the first tag is associated with the first account at a point-of-sale device.

10. The system of claim 8, wherein the operations further comprise:
sensing a plurality of tags including the first tag and the second tag,
determining a movement of the first attendee based on a result associated with sensing the first tag; and
determining a movement of the second attendee based on a result associated with sensing the second tag.

11. The system of claim 10, wherein the operations further comprise:
storing data of the movement of the first attendee and data of the movement of the second attendee.

12. The system of claim 8, wherein the operations further comprise:
determining that the first tag is within a proximity of a kiosk,
when the first tag is determined to be within the proximity of the kiosk, transmitting information related to the first account to the kiosk.

13. The system of claim 12, wherein the operations further comprise:
displaying the information related to the first account to the first attendee.

14. The system of claim 7, wherein the first account is the first user account.
